(19) United States
(12) Patent Application Publication
(10) Pub. No.: US 2016/0225020 A1
(43) Pub. Date: Aug. 4, 2016

(54) IDENTFYING MOBILE USERS TO RECEIVE ADVERTISEMENTS

(71) Applicant: GOOGLE INC., Mountain View, CA (US)

(72) Inventor: Ryan Petro, San Jose, CA (US)

(21) Appl. No.: 14/612,257

(22) Filed: Feb. 2, 2015

(51) Int. Cl. G06Q 30/02

(52) U.S. Cl. CPC G06Q 30/0255

(57) ABSTRACT

Determining if users should receive mobile advertisements comprises receiving, by a server at an advertisement provider system, usage data for an application provided by an application developer system and operating on a user computing device. The server analyzes the user usage data to develop a profile of the interaction of the user with the application, and identifies an amount of money spent by the user in conjunction with the application. The server estimates a lifetime spending value of the user based on the identified user spending. The application developer system transmits rules for determining an advertising schedule for advertisements to be provided based on the estimated lifetime value of the user. The server receives a notification that the user is interacting with the application and provides a particular advertisement to the user to the user on the application module of the application based on the determined advertising schedule.

### TECHNICAL FIELD

The present disclosure relates to identifying users that are unlikely to make in-app purchases and determining if the identified users should receive mobile advertisements. The present disclosure allows application developers to more effectively monetize users that are likely to make in-app purchases and users that are unlikely to make in-app purchases.

### BACKGROUND

Application developers create application software for users to install on mobile devices, such as a smartphone or a tablet computer, or other user computing devices. The applications can be any program, software, applet, or other user device module that can be operated by the user on the user device. Applications can be designed to provide services to a user such as communications, banking, social networking, gaming, exercise tracking, shopping, or any other suitable service. The applications may be downloaded by users from application distribution systems or directly from application developers. Certain applications are provided to the user for free, while other applications require a payment from the user to be downloaded.

Users are provided opportunities by certain applications to make purchases while operating the application. Transactions conducted while “in” an application are referred to as “in-app purchases.” In an example, in-app purchases may be conducted in gaming applications to purchase items such as additional lives, upgraded gaming paraphernalia, gaming tips, or any other suitable items. In another example, in-app purchases may be conducted in social networking applications to purchase items such as emoticons, additional features, virtual currencies, stickers or badges, or other suitable items.

Application developers may prefer to monetize an application by charging an initial fee for the application or through in-app purchases. Certain application developers have resisted monetizing an application through advertisements on the application because the advertisements are considered to be distracting to the user and to detract from the user experience.

Conventional application developers have not been provided with sufficient user data or analytics to determine when a user should be provided with an advertisement.

### SUMMARY

Techniques herein provide computer-implemented methods to determine if users should receive mobile advertisements. In an example embodiment, determining if users should receive mobile advertisements comprises a server at an advertisement provider system, a user computing device, and an application developer system. The server at an advertisement provider system receives usage data for an application provided by an application developer system and operating on a user computing device. The server analyzes the user usage data to develop a profile of the interaction of the user with the application, and identifies an amount of money spent by the user in conjunction with the application. The server estimates a lifetime spending value of the user based on the identified user spending. The application developer system transmits rules for determining an advertising schedule for advertisements to be provided based on the estimated lifetime value of the user. The server receives a notification that the user is interacting with the application and provides a particular advertisement to the user to the user on the application module of the application based on the determined advertising schedule.

In certain other example aspects described herein, systems and computer program products to determine if users should receive mobile advertisements are provided.

These and other aspects, objects, features, and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram depicting a system to determine whether to place an advertisement on a user device, in accordance with certain example embodiments.

FIG. 2 is a block flow diagram depicting a method to determine whether to place an advertisement on a user device, in accordance with certain example embodiments.

FIG. 3 is a block flow diagram depicting a method for an application developer to configure an application with an advertisement display module available, in accordance with certain example embodiments.

FIG. 4 is a block flow diagram depicting a method for the application developer to provide user data to advertisement provider system, in accordance with certain example embodiments.

FIG. 5 is a block flow diagram depicting a method for the application developer to configure advertisement module based on user usage data, in accordance with certain example embodiments.

FIG. 6 is a block diagram depicting a computing machine and module, in accordance with certain example embodiments.

### DETAILED DESCRIPTION OF EXAMPLE EMBODIMENTS

### Overview

The example embodiments described herein provide computer-implemented techniques for determining whether to place an advertisement on an application operating on a user device. In an example embodiment, an application developer configures an application to provide user usage data to an advertisement provider system. The advertisement provider system analyzes the user usage data and provides user profiles to the application developer. The application developer configures a set of rules for providing an advertisement to the user computing device that is operating the application. The advertisement provider system receives the user usage data for a particular user and determines whether the particular user should receive an advertisement. If a determination is made that user should receive advertisement, the advertisement provider system communicates instructions to the user computing device to display an advertisement.

In an example embodiment, an application developer configures an application with an advertisement display module available. The advertisement display module operating on the application on a user computing device is capable of receiving instructions from the advertisement provider system to display an advertisement to user. The application developer configures a developer account with the advertiser provider system and begins to receive analyzed user usage data and user profiles from the advertisement provider system. The analyzed user data may comprise an amount that a user has spent on in-app purchases, a total number of in-app purchases, a likelihood that the user will spend more on in-app purchases, user demographics, and other suitable data.

The analyzed user data may additionally include an estimate of the value of the user to the application developer if the user were provided with advertisements. For example, the advertisement provider system may determine an appropriate number of advertisements that may be shown based on the activity level and other data related to the user.

The application developer configures rules on the advertising module for when a user should receive an advertisement while operating the application. For example, the application developer may configure a rule that any user that has made less than one in-app purchase in the last 30 days should receive an advertisement for a subsequent utilization of the application. The application developer may configure rules for frequency of advertisements, categories of products advertised, or any other suitable rules. In certain examples, the application developer receives an estimate of the value of the in-app purchases that the user is likely to conduct and the value of the user based on advertisements the user could receive. The application developer determines if the value of the potential in-app purchases is sufficient to forego providing advertisements to the user. The application developer may elect to forego providing advertisements to the user to provide an improved user experience to the user.

After configuring the rules on the application module, the application developer associates the advertisement module with the developer account on the advertisement provider system. When analyzed user usage data and user profiles are supplied to the advertisement module from the advertisement provider system, the advertisement module determines if an advertisement should be provided to the user computing device. In certain embodiments, the determination that an advertisement should be provided to the user computing device, may be made by the advertisement selector 143 of the advertisement provider system 140, or by any other suitable component.

If an advertisement is to be provided to the user computing device, the advertisement module of the application developer system communicates a request to the advertisement provider system. The advertisement provider system selects an appropriate advertisement and transmits the advertisement to the user device. The user device displays the advertisement to the user.

The display is logged by the advertisement provider system. The logged display is used for billing to the party that bought the advertisement spot. The logged display can be further used for selecting the placement of future advertisements.

By using and relying on the methods and systems described herein, the application developer system and the advertisement provider system dynamically provide advertisements to only the users that meet the requirements configured by the application developer. As such, the systems and methods described herein may be employed to allow the application developer to monetize certain users via advertisements without negatively affecting the user experience of users that make in-app purchases. Certain users are allowed to enjoy advertisement fee application usage if the users are profitable to the application developer. Certain users are allowed to use the application without charge because the users are monetized in an alternate manner. Hence, the methods and systems described herein permit application developers to monetize additional users without the risk of negatively affecting the user experience of in-app purchasers.

### Example System Architectures

Turning now to the drawings, in which like numerals indicate like (but not necessarily identical) elements throughout the figures, example embodiments are described in detail.

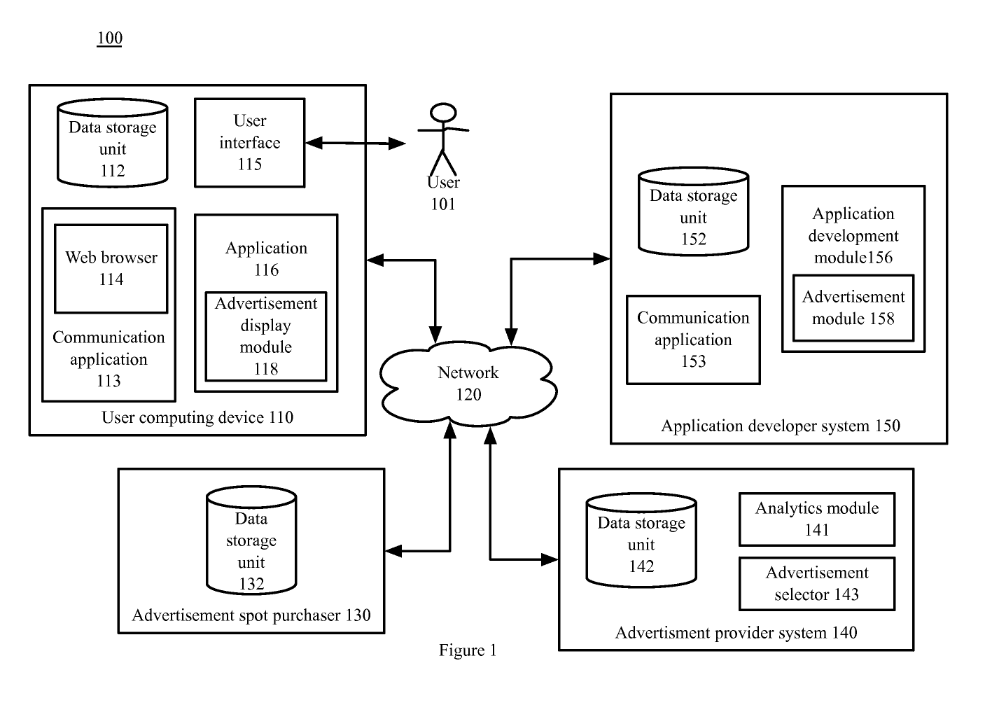

FIG. 1 is a block diagram depicting a system 100 to determine whether to place an advertisement on a user device, in accordance with certain example embodiments. As depicted in FIG. 1, the system 100 includes network computing systems 110, 130, 140, and 150 that are configured to communicate with one another via one or more networks 120. In some embodiments, a user 101 or other operator associated with a device must install an application and/or make a feature selection to obtain the benefits of the techniques described herein.

In example embodiments, the network 120 can include a local area network (“LAN”), a wide area network (“WAN”), an intranet, an Internet, storage area network (“SAN”), personal area network (“PAN”), a metropolitan area network (“MAN”), a wireless local area network (“WLAN”), a virtual private network (“VPN”), a cellular or other mobile communication network, Bluetooth, Bluetooth low energy, near field communication (“NFC”), Wi-Fi, or any combination thereof or any other appropriate architecture or system that facilitates the communication of signals, data, and/or messages. Throughout the discussion of example embodiments, it should be understood that the terms “data” and “information” are used interchangeably herein to refer to text, images, audio, video, or any other form of information that can exist in a computer-based environment.

Each network computing system 110, 130, 140, and 150 includes a device having a communication module capable of transmitting and receiving data over the network 120. For example, each network computing device 110, 130, 140, and 150 can include a server, desktop computer, laptop computer, tablet computer, a television with one or more processors embedded therein and/or coupled thereto, smart phone, handheld computer, personal digital assistant (“PDA”), or any other wired or wireless, processor-driven device. In the example embodiment depicted in FIG. 1, the network computing devices 110, 130, 140, and 150 are operated by users 101, advertisement spot purchaser operators, advertisement provider system operators, and application developer system operators, respectively.

An example user computing device 110 comprises a data storage unit 112, a communication application 113, a web browser 114, a user interface 115, an advertisement display module 118, and an application 116.

In an example embodiment, the data storage unit 112 comprises a local or remote data storage structure accessible to the user computing device 110 suitable for storing information. In an example embodiment, the data storage unit 112 stores encrypted information, such as HTML5 local storage.

In an example embodiment, the user 101 uses a communication application 113, such as a web browser 114 application, to view, download, upload, or otherwise access documents or web pages via a distributed network 120. In an example embodiment, the communication application 113 can interact with web servers or other computing devices connected to the network 120, including the user computing device 110, an advertisement provider system 140, and an application developer system 150. In an example embodiment, the web browser 114 can enable the user 101 to interact with web pages using the user computing device 110.

In an example embodiment, the user interface 115 enables the user 101 to interact with the application 116 and/or web browser 114. For example, the user interface 115 may be a touch screen, a voice-based interface, or any other interface that allows the user 101 to provide input and receive output from an application or module on the user computing device 110. In an example embodiment, the user 101 interacts via the user interface 115 with the application 116 and/or web browser 114 to select and download applications from the application developer system 150 or the advertisement provider system 140.

In an example embodiment, the advertisement display module 118 communicates with the advertisement provider system 140 or the application developer system 150 to provide user usage data and to receive advertisements. For example, if the advertisement provider system 140 is requested to provide an advertisement to the user device 110, then the advertisement provider system 140 provides a communication to the advertisement display module 118. The advertisement display module 118 displays the advertisement in a manner configured by the application developer system 150. In an example, the application developer system 150 configures the advertisement to be displayed in a banner advertisement, a pop-up advertisement, or any suitable advertisement display. The advertisement display module 118 operates on the application 116, on the user computing device 110, or in any suitable manner.

In an example embodiment, the application 116 is a program, function, routine, applet, or similar entity that exists on and performs its operations on the user computing device 110. Applications can be designed to provide services to a user such as communications, banking, social networking, gaming, exercise tracking, shopping, or any other suitable service. The applications may be downloaded by users from application distribution systems or directly from application developers. Certain applications are provided to the user 101 for free, while other applications require a payment from the user 101 to be downloaded.

In certain example embodiments, the user 101 must install the application 116 and/or make a feature selection on the user computing device 110 to obtain the benefits of the techniques described herein. In an example embodiment, the user 101 may access the application 116 on the user computing device 110 via the user interface 115. In an example embodiment, the application 116 may be associated with the application developer system 150, the advertising provider system 140, or any other suitable party.

In certain example embodiments, one or more functions herein described as performed by the application 116 may also be performed by a web browser 114 application, for example, a web browser 114 application associated with a application provider system 140 or associated with the payment processing system 140. In certain example embodiments, one or more functions herein described as performed by the application 116 may also be performed by the user computing device operating system. In certain example embodiments, one or more functions herein described as performed via the web browser 114 may also be performed via the application 116.

In an example embodiment, the application developer system 150 communicates with the user computing device 110, the advertisement provider system 140, the advertisement spot purchaser 130, or any suitable party via the network 120. An example application developer system 150 comprises a data storage unit 152, a communication application 153, an application development module 156, and an advertisement module 158.

In an example embodiment, the data storage unit 152 comprises a local or remote data storage structure accessible to components of the application developer system 150 suitable for storing information. In an example embodiment, the data storage unit 152 stores encrypted information, such as HTML5 local storage.

In an example embodiment, an application developer system 150 operator uses a communication application 153, such as a web browser application, to view, download, upload, or otherwise access documents or web pages via a distributed network 120. In an example embodiment, the communication application 153 can interact with web servers or other computing devices connected to the network 120, including the user computing device 110, and advertisement spot purchaser 130, and an advertisement provider system 140.

The application developer system 150 may be utilized by an operator or others to develop applications 116, distribute applications 116, configure developer accounts on an advertisement provider system 140, receive user usage data and analytics, configure advertisement modules 158, and perform any other suitable tasks for developing and managing applications 116.

In an example embodiment, the application development module 156 is a program, function, routine, applet, or similar entity that exists on and performs operations on the application developer system 150. In certain example embodiments, application development module 156 must be installed and/or had a feature selection made on the application developer system 150 to obtain the benefits of the techniques described herein. The application development module 156 may be used to design, configure, code, revise, or distribute an application 116. The application development module 156 may be any platform, programming environment, software package, hardware accessory, or any suitable module to assist with the development of an application 116.

The advertisement module 158 may be utilized by an operator of the application developer system 150 or others to coordinate the placement of advertisements on a user computing device 110. The operator may use the advertisement module 158 to receive analytics from the advertisement provider system 140, configure rules for providing advertisements, apply the rules, and provide advertisement requests to the advertisement provider system 140. The advertisement module 158 can be associated with the developer account on the advertisement provider system 140 to allow the advertisement placement on the user computing device 110 to be performed automatically.

The advertisement provider system 140 provides advertisements to user computing devices 110 to be displayed on, or in conjunction with, an application 116. The advertisement provider system 140 can receive advertisement data from an advertisement spot purchaser 130, receive a request to provide an advertisement, communicate the advertisement to a user computing device 110, or perform any other suitable actions to complete the process. An advertisement provider system 140 may further provide an opportunity for users 101 to purchase applications 116, download applications 116, update applications 116, or purchase or download any other suitable software, computer programs, digital media. An example advertisement provider system 140 comprises an analytics module 141, a data storage unit 142, and an advertisement selector 143. In an example embodiment, the application developer system 150 has a developer account with the advertisement provider system 140. For example, the advertisement provider system 140 may receive a developer operator's username and password and allow the operator to access services provided by the advertisement provider system 140. In an example embodiment, the advertisement provider system 140 communicates with the application 116 resident on the user computing device 110 to obtain user usage data, provide advertisements, if communicate other data and information. In another example embodiment, the advertisement provider system 140 communicates with the advertisement spot purchaser 120 to sell advertisement spots on the application 116, receive advertisement data, or exchange other suitable data and information. In an example embodiment, the advertisement provider system 140 communicates with the application developer system 150 to provide analytics, to receive application information, and to communicate other data information.

In an example embodiment, the analytics module 141 receives user usage data and analyzes the data to provide information and recommendations to the application developer system 150. The analytics module 141 generates analytical data about a user's 101 usage of the application 116, such as user demographic information, frequency and length of use of the application 116 by the user 101, in-app purchase history of the user 101, and other suitable data. The data may be communicated to the application developer system 150 or accessed by the application developer system 150 on the developer account on the advertisement provider system 140.

In an example embodiment, the advertisement selector 143 receives a request to provide an advertisement to be displayed on the advertisement module 118 on the user computing device 110. The advertisement selector 143 accesses a database of available advertisements to make the selection. The advertisement selector 143 may select an appropriate advertisement to communicate to the advertisement module 118 based on configured rules or other selection criteria established by the application developer system 150, the advertisement spot purchaser 130, or any other suitable party.

In an example embodiment, the data storage unit 142 comprises any local or remote data storage structure accessible to the payment processing system hands-free module 141 suitable for storing information. In an example embodiment, the data storage unit 142 stores encrypted information, such as HTML5 local storage. In an example embodiment, the data storage unit 142 stores user financial account information and/or user credit account information.

An example advertisement spot purchaser 130 comprises a data storage unit 132. The data storage unit 132 comprises a local or remote data storage structure accessible to the merchant computing device 150 suitable for storing information. In an example embodiment, the data storage unit 152 stores encrypted information, such as HTML5 local storage.

The advertisement spot purchaser 130 can provide advertisement data to the advertisement provider system 140 to be displayed to a user 101. The advertisement spot purchaser 130 may purchase a configured number of spots. The advertisement spot purchaser 130 may be charged on a per view basis, a per click basis, per action basis, or any other suitable system. The advertisement spot purchaser 130 may request certain applications on which to display the advertisements. Any other advertisement options may be requested or configured by the advertisement spot purchaser 130.

It will be appreciated that the network connections shown are example and other means of establishing a communications link between the computers and devices can be used. Moreover, those having ordinary skill in the art having the benefit of the present disclosure will appreciate that the user computing device 110, the advertisement spot purchaser 130, the advertisement provider system 140, and the application developer system 150 illustrated in FIG. 1 can have any of several other suitable computer system configurations. For example, a user computing device 110 embodied as a mobile phone or handheld computer may or may not include all the components described above.

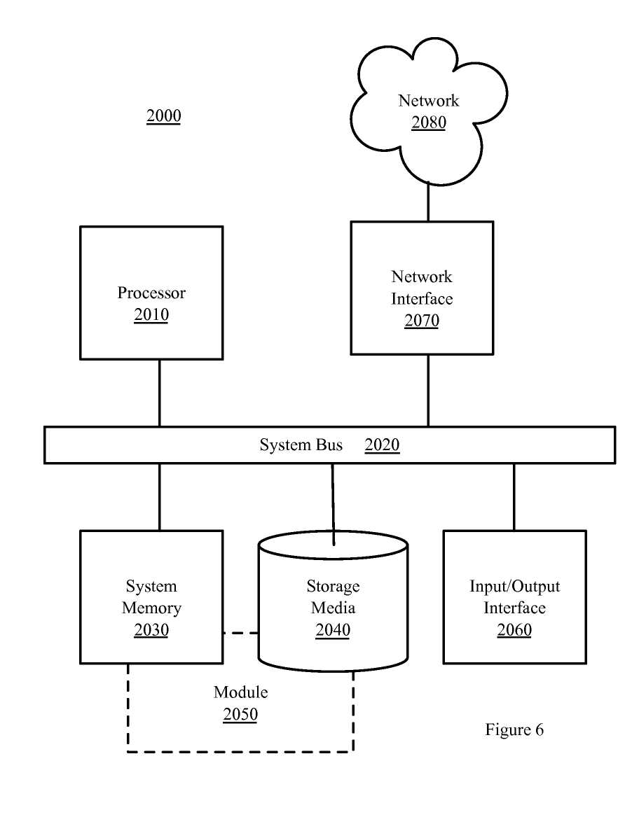

In example embodiments, the network computing devices and any other computing machines associated with the technology presented herein may be any type of computing machine, such as, but not limited to, those discussed in more detail with respect to FIG. 6. Furthermore, any modules associated with any of these computing machines, such as modules described herein or any other modules (scripts, web content, software, firmware, or hardware) associated with the technology presented herein may by any of the modules discussed in more detail with respect to FIG. 6. The computing machines discussed herein may communicate with one another as well as other computing machines or communication systems over one or more networks, such as network 120. The network 120 may include any type of data or communications network, including any of the network technology discussed with respect to FIG. 6.

### Example Processes

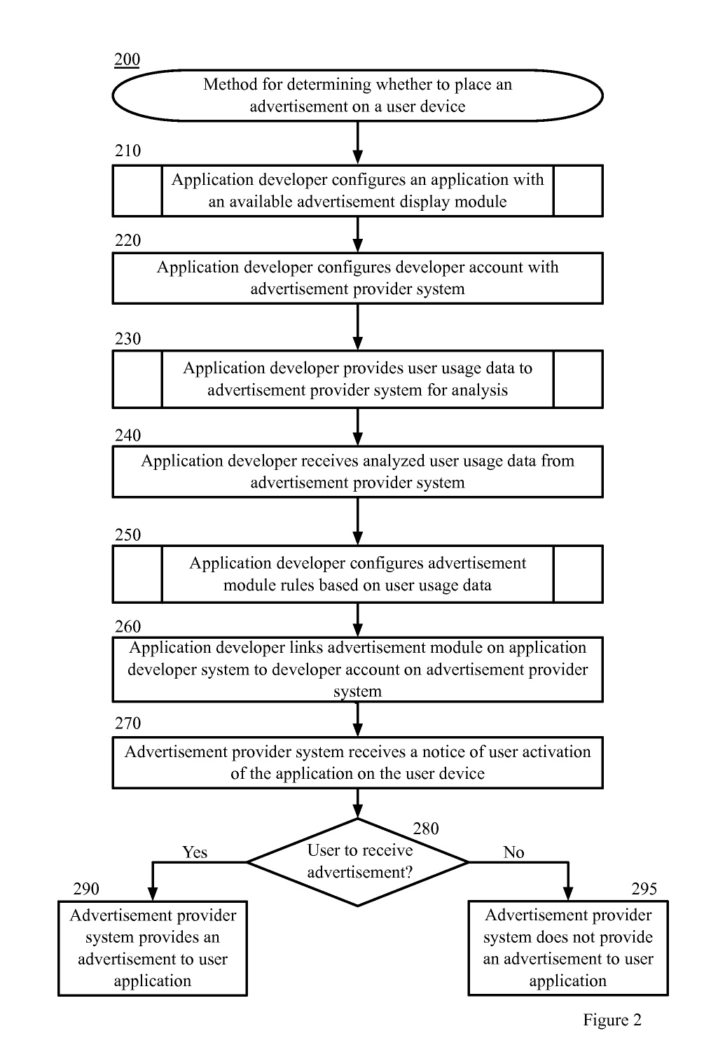

The example methods illustrated in FIGS. 2-5 are described hereinafter with respect to the components of the example operating environment 100. The example methods of FIGS. 2-5 may also be performed with other systems and in other environments.

FIG. 2 is a block diagram depicting a method 200 to determine whether to place an advertisement on a user computing device 110, in accordance with certain example embodiments. The method 200 is described with reference to the components illustrated in FIG. 1.

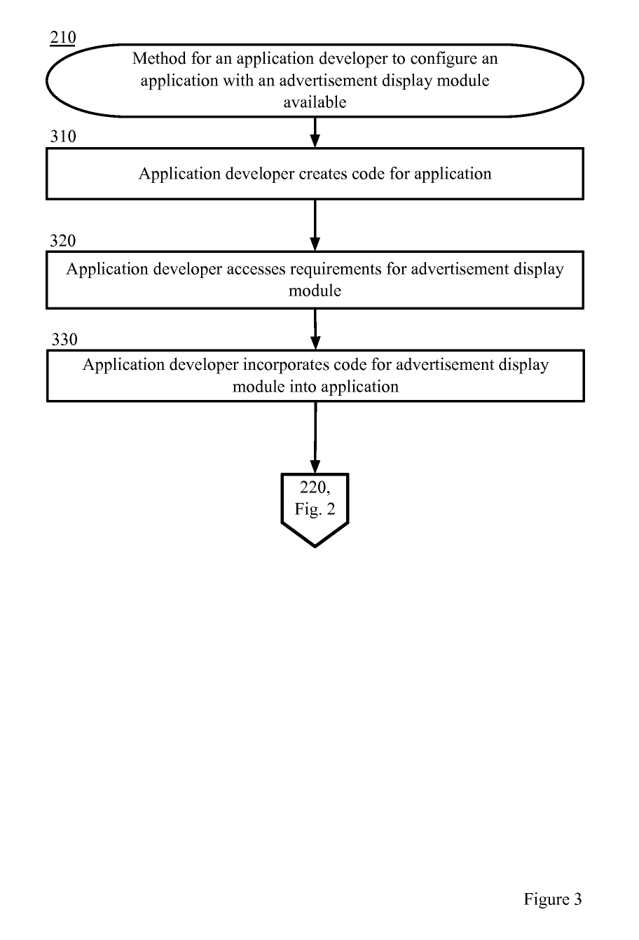

In block 210, the application developer system 150 configures an application 116 with an available advertisement display module 118. Block 210 is described in greater detail hereinafter with reference to the method 210 described in FIG. 3.

FIG. 3 is a block diagram depicting a method 210 for an application developer 150 to configure an application 116 with an advertisement display module 118 available, in accordance with certain example embodiments. The method 210 is described with reference to the components illustrated in FIG. 1.

In block 310, the application developer system 150 creates code for the application 116. Operators and others at the application developer system 150 create application software for users 101 to install on mobile devices, such as a smartphone or a tablet computer, or other user computing devices. The applications 116 can be any program, software, applet, or other user device module that can be operated by the user 101 on the user computing device 110. Applications 116 can be designed to provide services to a user 101 such as communications, banking, social networking, gaming, exercise tracking, shopping, or any other suitable service.

The application 116 can be designed with a user interface system to allow interaction with the user 101. The application 116 may be designed to be used on one or more particular types of user computing device 110, or the application 116 may be designed to be used on any type of user computing device 110. The application 116 may be associated with another application or module of the user computing device 110, such as communication application 113, and require certain functions of the application or module to operate.

The application 116 can be developed on a standardized software platform or any other suitable software platform. The completed code is operable to allow the application to be installed on a user computing device 110 and operated in a manner consistent with the design intent.

In block 320, the application developer system 150 accesses requirements for an advertisement display module 118. The advertisement display module 118 may access advertisement display module 118 requirements in a database stored on the data storage unit 142 of the advertisement provider system 140 over the network 120. The requirements may be stored in any other suitable location. The requirements may comprise instructions for the manner in which the advertisement display module 118 is to be configured in the application code to provide advertisements to the user 101. The database may provide examples of the code or sections of the code that may be copied and used in the development of the advertisement display module 118. The requirements provide guidance for placement of the advertisement on the display of the application 116, timing of the advertisement, appearance of the display, size of the display, or any other suitable characteristics of an advertisement that will be presented with the advertisement display module 118.

In block 330, the application developer system 150 incorporates the code for the advertisement display module 118 into the application 116. After accessing and retrieving the requirements and any available code for the advertisement display module 118, the application developer system 150 configures the programming code of the application 116 to include the code for the advertisement display module 118. The advertisement display module 118 may be written into the code, plugged into the code as a module or other component of the code, or in anyway associated with the code that is written for the application 116. The application 116 is programmed such that, after installation on a user computing device 110, the advertisement display module 118 operating on the application 116 is capable of receiving instructions from the advertisement provider system 140 to display an advertisement to user 110.

From block 330, the method 210 returns to block 220 of FIG. 2.

Returning to FIG. 2, in block 220, the application developer system 150 configures a developer account with the advertisement provider system 140. An operator of the application developer system 150 accesses the advertisement provider system 140 over the network 120, via email, text, over the Internet, or via any suitable communication technology. The developer account is configured with the application developer system 150 identification information, preferences, information about applications 118 developed by the application developer system 150, analyzed data preferences, financial account information, and any other suitable information.

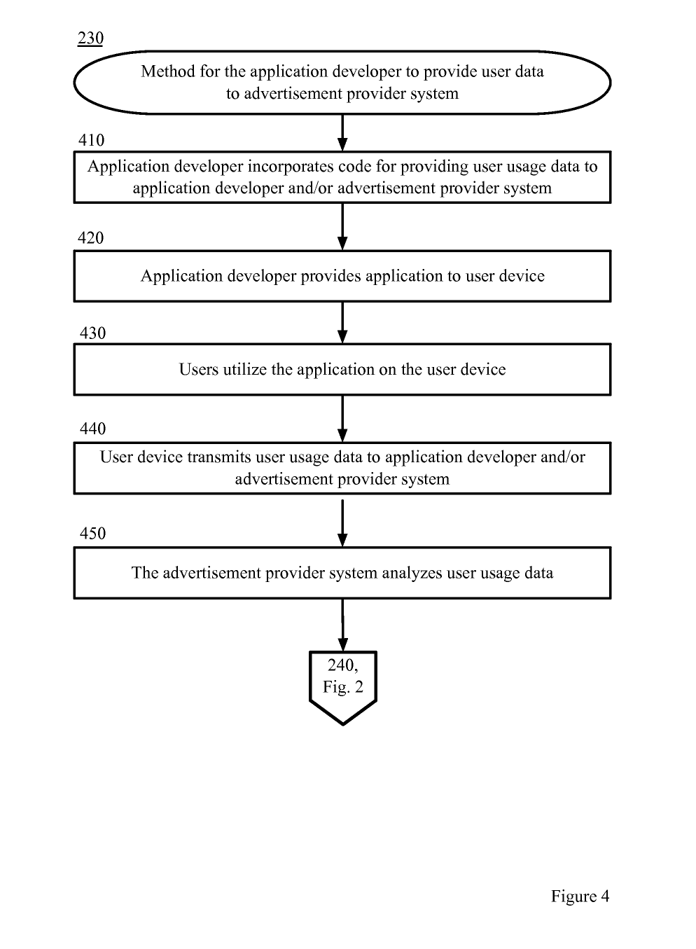

In block 230, the application developer system 150 provides user usage data to advertisement provider system 140. Block 230 is described in more detail hereinafter with reference to the method 230 described in FIG. 4.

FIG. 4 is a block diagram depicting a method 220 for the application developer system 150 to provide user usage data to advertisement provider system 140, in accordance with certain example embodiments. The method 230 is described with reference to the components illustrated in FIG. 1.

In block 410, application developer system 150 incorporates code for providing user usage data to the application developer system 150 and/or advertisement provider system 140 in to the application 116. The user usage data can include user demographic information, frequency and length of use of the application 116 by the user 101, in-app purchase history of the user 101, user computing device 110 information, and other suitable data. The advertisement display module 118 may access code or requirements in a database stored on the data storage unit 142 of the advertisement provider system 140 over the network 120. The requirements may comprise instructions for how the advertisement display module 118 is to be configured in the application code to provide the user usage data. The database may provide examples of the code or sections of the code that may be copied and used in the development of the advertisement display module 118. The requirements provide guidance for how the usage data should be collected, transmitted, stored, and sorted.

The application developer system 150 incorporates the code for providing the usage data into the application 116. After accessing and retrieving the requirements and any available code, the application developer system 150 configures the programming code of the application 116 to include the code for providing the user usage data. The providing of the user usage data may be written into the code, plugged into the code as a module or other component of the code, or in any way associated with the code that is written for the application 116. The application 116 is programmed such that, after installation on a user computing device 110, the application 116 is capable of collecting the user usage data and providing the data to the advertisement provider system 140 and/or the application developer system 150. In certain embodiments, certain data may not be collected or transmitted unless authorized by the user 101.

In block 420, application developer system 150 provides the application 116 to the user computing device 110. In an example, a user 101 may navigate a web browser 114 of a user computing device 110 to a webpage of an application distributer system 150 or an advertisement provider system 140. In the example, the advertisement provider system 140 is an example of an application distributer. In the example, all the functions of the application distributer system 150, such as providing an opportunity for users 101 to purchase applications 116, download applications 116, update applications 116, or purchase or download any other suitable software, computer programs, digital media, are performed by the advertisement provider system 140. In alternate embodiments, the application distributer system 150 can be a separate system, a system that is associated with the advertisement provider system 140, or any other system or party.

In the example, the application developer system 150 provides the application to the advertisement provider system 140 for distribution. For example, the user computing device 110 navigates a web browser 114 of a user computing device 110 to a webpage of the advertisement provider system 140. The user 101 makes a selection of the application 101 on the webpage with a request to provide the application 116 to the user computing device 110. The advertisement provider system 140 communicates instructions to the user computing device 110 to download the application 116. The application is downloaded onto the user computing device 110 and the user 101 is provided access to the application 116 by the user computing device 110.

In another example, the application developer system 150 provides the application 116 to the user computing device 110. The user computing device 110 may navigate a web browser 114 of a user computing device 110 to a webpage of the application developer system 150 and download the application 116 in a similar manner as described above with reference to the providing of the application 116 by the advertisement provider system 140. In another example, the application 116 may be installed on the user computing device 110 by the manufacturer and provided with the user computing device 110 at the time of purchase. The application 116 may be obtained by the user computing device 110 from any suitable location at any suitable time.

In block 430, one or more users 101 utilize the application 116 on one or more user computing devices 110. In an example, after downloading the application 116 to the user computing device 110, the user 101 initiates a session with the application 116 by selecting an object on the user interface 115 of the user computing device 110 that opens the application 116. The user 101 may interact with the application 116, such as by configuring an account, viewing a media presentation, conducting transactions, requesting information, interacting with other application 116 users, or performing any suitable actions provided by the application 116.

In block 440, the user computing device transmits user usage data to application developer system 150 and/or advertisement provider system 140. When the user 101 interacts with the application 116, the application 116 gathers user usage data based on the programed code installed by the application developer system 150. The user usage data may comprise an amount of time that the user 101 is interacting with the application 116, in-app and other purchases being made by the user 101, the number of times that the user 101 initiates the application 101, the model or type of user computing device 110 that the user 101 is using to interact with the application 116, demographic information about the user 110, related applications that are resident on the user computing device 110, or any other suitable user usage data.

The user computing device 110 transmits the user usage data to the application developer system 150 and/or the advertisement provider system 140. In certain examples, the user computing device 110 transmits the user usage data directly to the advertisement provider system 140 for analysis via the Internet over the network 120, via email, text, BLUETOOTH, or via any other suitable communication technology. In certain examples, the user computing device 110 transmits the user usage data to the application developer system 150 which will be re-transmitted to the advertisement provider system 140. Any other suitable method for transmitting the user usage data to the advertisement provider system 140 may be utilized.

In block 450, the advertisement provider system 140 analyzes user usage data. After receiving the user usage data, the analytics module 141 on the advertisement provider system 140 analyzes the user usage data to produce a profile of a user 101 or a group of users. The profile generated by the analytics module 141 includes characteristics of the user 101, such as an amount that user 101 has spent on in-app purchases, a total number of in-app purchases, a likelihood that the user will spend more on in-app purchases, user demographics, and other suitable data.

The analyzed user usage data may additionally include an estimate of the value of the user 101 to the application developer system 150 over the lifetime of the user's 101 interaction with the application 116. That is, based on the history of in-app purchases and other purchases of the user 101, the analytics module 141 generates an estimate of how much the user 101 may be expected to spend on the application 116. The estimate may be based on the previous purchases of the user 101 in the application 116, related applications, previous versions of the application 116, or any other suitable applications. The estimate may be based on the purchase histories of similar users. The estimate may be based on the expected lifetime of the user's usage of the application 116. For example, the analytics module 141 calculates an expected length of time that the user 101 will actively engage the application 116. For example, a social network application may have an expected lifespan of 10 years. In another example, a simple game application may only have an expected lifespan of 1 year. Based on the purchase history of the user 101 as described and the expected lifespan of the application 116, the analytics module 141 extrapolates a lifetime spend of the user 101 on the application 116.

The analytics module 141 can additionally calculate a value of the user 101 to the application developer system 150. Based on the usage history of the user 101 and expected advertisement spot rates, the analytics module 141 calculates a value of the user 101 if the user 101 were provided with advertisements. In an example, the advertisement provider system determines an appropriate number of advertisements that may be shown based on the activity level and other data related to the user 101 and determines the value of showing that number of advertisements.

In certain examples, the user usage data is collected for a configured amount of time before the analysis is generated. For example, the advertisement provider system 140 does not generate an analysis until 1 month, 3 months, or 6 months of user usage data are collected. The length of time may be configured to ensure that enough user usage data is collected to make accurate estimates of the user value. Different applications may require different configured amounts of time required. For example, an application 116 that is used frequently and offers many opportunities to make an in-app purchase may require a shorter amount of time to make an accurate estimate as an application 116 that is used infrequently or has few opportunities to make an in-app purchase.

From block 450, the method 230 returns to block 240 of FIG. 2.

Returning to FIG. 2, in block 240, the application developer system 150 receives analyzed user usage data from the advertisement provider system 140. The advertisement provider system 140 provides the analyzed user usage data to the application developer system 150 via the Internet over the network 120, via email, text, or any other suitable communication technology. The communicated analyzed data may include identifiers for the user 101, a user account identifier, the analyzed data, the lifetime value estimates for in-app purchases, the lifetime value estimates for advertisements, and any other suitable data.

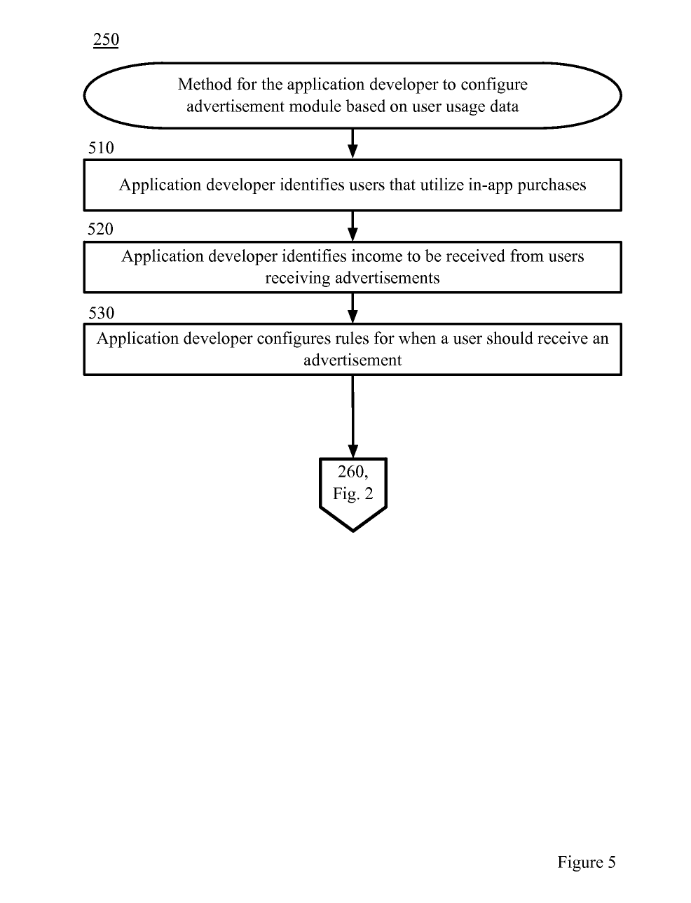

In block 250, the application developer system 150 configures advertisement module 158 rules based on the user usage data. Block 250 is described in more detail hereinafter with reference to the method 250 described in FIG. 5.

FIG. 5 is a block diagram depicting a method 250 for the application developer system 150 to configure advertisement module 158 rules based on user usage data, in accordance with certain example embodiments. The method 230 is described with reference to the components illustrated in FIG. 1.

In block 510, the application developer system 150 identifies users 101 that utilize in-app purchases. The application developer system 150 can receive the identification of users 101 that make in-app purchases in any suitable format. For example, the application developer system 150 can receive a ranking of in-app purchasers and an identification of an individual user's 101 position in that ranking, such as number 50 out of 1000. In another example, the application developer system 150 can receive a total amount spent by the user 101. In another example, the application developer system 150 can receive an expected lifetime value of the user 101 that predicts how much the user 101 may be expected to spend on in-app purchases on the application 116. In another example, the application developer system 150 can receive a rating of the user 101 spending. The rating may be a letter grade, such as an A or B, a descriptive rating, such as “GOOD” or “POOR”, a number rating, such as 0-100, or any other suitable rating system.

The application developer system 150 can receive an input from an operator of the application developer system 150 that specifies the characteristic(s) that are required to label a user 101 as an “in-app purchaser.” For example, the operator may configure the application developer system 150 to consider a user 101 with an expected lifetime value greater than $10.00 to be an in-app purchaser. In another example, the operator may configure the application developer system 150 to consider a user 101 that has purchased greater than $3.00 in the first month of use of the application 116 to be an in-app purchaser. In another example, the operator may configure the application developer system 150 to consider a user 101 that has purchased greater than $10.00 in a related application to be an in-app purchaser. In another example, the operator may configure the application developer system 150 to consider a user 101 that has a rating of A or B to be an in-app purchaser. Any other suitable standard may be configured to identify an in-app purchaser.

In block 520, the application developer system 150 identifies income to be received from users 101 receiving advertisements on the advertisement module 158. The advertisement provider system 140 provides information to the advertisement module 158 on the application developer system 150 that specifies the amount of money that would be earned by providing advertisements to the user 101 on the application 116. The information can be provided as an expected lifetime advertising value of the user 101, as a value per user session with the application 116, as a value per month, or in any other suitable format.

The determination of the value of advertising to the user 101 can incorporate a possible decrease in use of the application 116 by the user 101 due to the advertisements. That is, a user 101 that is receiving advertisements on the application 116 may use the application 116 less frequently than when not receiving advertisements due to a possible decrease in the satisfaction level of the user experience on the application 116. The decrease in use may be included in the calculation of the value of advertising to the user 101.

The value of advertising to the user 101 is calculated, by the advertisement module 158, based on the amount that the advertisement provider system 140 will pay to present an advertisement on the advertisement display module 118. For example, if the advertisement provider system 140 is willing to pay $0.05 per advertisement presented, and the advertisement provider system 140 provides 10 advertisements per day to the user 101 on the advertisement display module 118, then the value of advertising to the user 101 is $0.50 per day. If the user 101 of the example is expected to use the application 116 for 100 days before discontinuing use, then the lifetime value of advertising to the user 101 is equal to $50.00($0.50*100=$50.00).

The amount that the advertisement provider system 140 will pay to present an advertisement on the advertisement display module 118 may vary based on the history of purchases of the user 101, the frequency that a user 101 is expected to use the application 116, the negotiated price charged to the advertisement spot purchaser 130, or any other suitable factor. The amount that the advertisement provider system 140 will pay may be based on factors such as a cost per presentation, cost per click, cost per action taken by the user 101, or any other suitable factor.

In block 530, the application developer system 150 configures rules on the advertisement module 158 for when a user 101 should receive an advertisement. For example, the advertisement module 158 compares the user usage data of a user 101 to the expected value of advertising to the user 101. If the user 101 is likely to spend more on in-app purchases, then the advertisement module 158 elects to forego the advertisements to that user 101. If the advertisement module 158 determines that more money will be received from advertisements than from in-app purchases by the user 101, then the advertisement module 158 elects to provide advertisements.

The number or frequency of the advertisements may be configured based on the disparity between the amount the user 101 will likely spend more on in-app purchases and the amount expected value of advertising to the user 101. That is, if the user 101 will spend less than $5 on in-app purchases, but the user 101 is worth $50 if provided with advertisements, then the application developer system 150 may elect to provide a greater number of advertisements to that user 101 than another user that will spend $30.00 on in-app purchases.

In another example, the advertisement module 158 configures a rule that any user 101 that has made less than one in-app purchase in the last 30 days should receive advertisements for subsequent uses of the application 116. The advertisement module 158 may configure rules for frequency of advertisements, categories of products advertised, or any other suitable rules.

In another example, the advertisement module 158 prepares an advertisement schedule for the user 101. That is, the advertisement module 158 compares the profile of the user 101 to the rules provided by the advertisement development system 150 and associates an advertisement schedule based on the rules. For example, the advertisement schedule determines a number of advertisements the user 101 is to receive per action on the application 116. In another example, the advertisement schedule determines a number initiations of the application 116 before the user 101 is to receive an advertisement, such as an advertisement every third time the application 116 is initiated. In another example, the advertisement schedule provides more advertisements to a user 101 that has a lower estimated lifetime value, and less advertisements to a user 101 that has a higher estimated lifetime value. The advertisement schedule may be stored on the data storage unit 142 on the advertisement provider system 140.

From block 530, the method 250 returns to block 260 of FIG. 2.

In block 260, the application developer system 150 links the advertisement module 158 on the application developer system 150 to the developer account on advertisement provider system 140. The application developer system 150 ties the data generated by the analytics module 141 to the advertisement module 158 to allow stored user profiles to be compared to the configured rules. The application developer system 150 links the advertisement module 158 to the developer account by communicating a request to the analytics module 141 to provide user analytics directly to the advertisement module 158. The advertisement module 158 is configured to receive the user analytics and to provide advertisement configuration and rules to the application developer system 150. In another example, the rules of the advertisement module 158 are provided to the advertisement provider system 140 to allow advertisement provider system 140 to use the rules and preferences.

In block 270, the advertisement provider system 140 receives a notice of a user activation of the application 116 on the user computing device 110. The notice may be provided directly by the user computing device 110 when the user 101 initiates the application 116. Additionally or alternatively, the notice may be provided by the user computing device 110 to the application developer system 150. The application developer system 150 may forward the notification to the advertisement provider system 140. The user computing device may communicate the notice to the advertisement provider system 140 and/or the application developer system 150 via an Internet connection over the network 120, via text, email, or any other suitable communication technology.

In an example, the user 101 selects an option on the user computing device 110 to initiate the application 116. The application 116 opens and a user interface of the application 116 is presented to the user 101. The application 116 or the user computing device 101 recognizes instructions in the configuration of the application 116 to provide the notification to the advertisement provider system 140 and/or the application developer system 150. The application 116 or the user computing device 101 initiates the communication to provide the notification as configured.

In block 280, the application 116, the application developer system 150, or the advertisement provider system 140 determines if the user 101 is to receive an advertisement. For example, the advertisement selector 143 of the advertisement provider system 140 compares the profile of the user 101 to the rules provided by the application developer system 150. In another example, the advertisement module 158 of the application developer system 150 performs the comparison of the profile of the user 101 to the rules provided by the application developer system 150. Examples of the rules are provided in greater detail in block 530 of FIG. 5. If the user 101 is to be provided with an advertisement, then the method 200 proceeds to block 290.

In block 290, the advertisement selector 143 of the advertisement provider system 140 selects an appropriate advertisement and provides the advertisement to the application 116 on the user computing device 110. The appropriate advertisement may be an advertisement that meets the qualifications of the advertisement schedule that is associated with the user 101. In an example, the advertisement schedule that is associated with the user 101 may have a queue of advertisements available for subsequent user interactions with the application 116. In another example, the advertisement selector 143 may access a database of advertisements on the data storage unit 142 and select an appropriate advertisement based on the user profile at the time of the user 101 interaction with the application 116. Any suitable process may be utilized by the advertisement selector 143.

In an alternate embodiment, if the advertisement module 158 of the application developer system 150 performs the comparison of the profile of the user 101 to the rules provided by the application developer system 150, then the advertisement module 158 provides a communication of a request to the advertisement selector 143 to provide the advertisement to the application 116 on the user computing device 110.

The advertisement selector 143 or other component of the advertisement provider system 140 stores data associated with the presentation of the advertisement. The data may include a record that the user 101 received the advertisement, a record that the user 101 clicked the advertisement, a record that the user 101 performed an action associated with the advertisement, or any other suitable record. The advertisement provider system 140 may provide the records associated with the advertisement to the advertisement spot purchaser 130 with an invoice for payment.

Returning to block 280, if the user 101 is not to be provided with an advertisement, then the method 200 proceeds to block 295. In block 295, the advertisement selector 143 of the advertisement provider system 140 does not provide an advertisement to the application 116 on the user computing device 110. The user 101 operates the functions of the application 116 without receiving an advertisement.

### Other Example Embodiments

FIG. 6 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain example embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 may also include volatile memories such as random access memory (“RAM”), static random access memory (“SRAM”), dynamic random access memory (“DRAM”), and synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read only memory (“CD-ROM”), a digital versatile disc (“DVD”), a Blu-ray disc, a magnetic tape, a flash memory, other non-volatile memory device, a solid state drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCI”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (“SOC”), system on package (“SOP”), or ASIC device.

In situations in which the systems discussed here collect personal information about users, or may make use of personal information, the users may be provided with an opportunity or option to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described herein. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the scope of the following claims, which are to be accorded the broadest interpretation so as to encompass such alternate embodiments.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

What is claimed is:

1. A computer-implemented method to determine to serve mobile advertisements, comprising:
receiving, by one or more computing devices, user usage data for a particular application operating on a user computing device associated with a user, the particular application being provided by an application developer computing system;
analyzing, by the one or more computing devices, the user usage data to develop a profile of the interaction of the user with the particular application;
identifying, by the one or more computing devices, an amount of money spent by the user in conjunction with the particular application;
estimating, by the one or more computing devices, a lifetime spending value of the user based on the identified user spending;
receiving, by the one or more computing devices, one or more rules from the application developer computing system to determine an advertising schedule for advertisements to be provided to the user on an application module of the application based on the estimated lifetime value of the user
receiving, by the one or more computing devices, a notification that the user is interacting with the particular application on the user computing device; and
providing, by the one or more computing devices, a particular advertisement to the user via the application module of the particular application based on the determined advertising schedule.

2. The computer-implemented method of claim 1, further comprising providing, by the one or more computing devices, an expected value to the application developer computing system to allow the advertisements to be provided to the user on an application module of the application.

3. The computer-implemented method of claim 1, wherein a particular rule of the one or more rules specifies that the user is to be placed on the advertising schedule if the lifetime spending value of the user is below a configure threshold.

4. The computer-implemented method of claim 1, wherein the advertising schedule provides a greater number of advertisements to the user based upon a determination that the lifetime spending value of the user is below a configure threshold and a lesser number of advertisements to the user based upon a determination that the lifetime spending value of the user is above a configure threshold.

5. The computer-implemented method of claim 1, wherein the advertising schedule does not provide any advertisements to the user based upon a determination that the lifetime spending value of the user is above a configure threshold.

6. The computer-implemented method of claim 1, further comprising:
receiving, by the application developer computing system, the profile of the interaction of the user with the application, the profile comprising the lifetime spending value of the user based on the user spending;
communicating, by the application developer computing system, the one or more rules determining the advertising schedule for advertisements to be provided to the user on the application module of the application based on the determined lifetime value of the user.

7. The computer-implemented method of claim 2, wherein the advertising schedule does not provide any advertisements to the user based upon a determination that the lifetime spending value of the user is above the expected value to the application developer for allowing the advertisements to be provided to the user.

8. A computer program product, comprising:
a non-transitory computer-readable storage device having computer-readable program instructions embodied thereon that when executed by a computer cause the computer to determine to serve mobile advertisements, the computer-readable program instructions comprising:
computer-readable program instructions to receive user usage data for a particular application operating on a user computing device associated with a user, the particular application being provided by an application developer computing system;
computer-readable program instructions to identify an amount of money spent by the user in conjunction with the particular application;
computer-readable program instructions to estimate a lifetime spending value of the user based on the identified user spending;
computer-readable program instructions to receive one or more rules from the application developer computing system for determining an advertising schedule for advertisements to be provided to the user on an application module of the particular application based on the estimated lifetime value of the user
computer-readable program instructions to receive a notification that the user is interacting with the particular application on the user computing device; and
computer-readable program instructions to provide a particular advertisement to the user to the user on the application module of the particular application based on the determined advertising schedule.

9. The computer program product of claim 8, further comprising computer-readable program instructions to provide an expected value to the application developer computing system to allow the advertisements to be provided to the user via an application module of the application.

10. The computer program product of claim 8, wherein a particular rule of the one or more rules specifies that the user is to be placed on the advertising schedule if the lifetime spending value of the user is below a configure threshold.

11. The computer program product of claim 8, wherein the advertising schedule provides a greater number of advertisements to the user based upon a determination that the lifetime spending value of the user is below a configure threshold and a lesser number of advertisements to the user based upon a determination that the lifetime spending value of the user is above a configure threshold.

12. The computer program product of claim 8, wherein the advertising schedule does not provide any advertisements to the user based upon a determination that the lifetime spending value of the user is above a configure threshold.

13. The computer program product of claim 8, further comprising:
computer-readable program instructions to receive the profile of the interaction of the user with the particular application, the profile comprising the lifetime spending value of the user based on the user spending;
computer-readable program instructions to communicate the one or more rules determining the advertising schedule for advertisements to be provided to the user on the application module of the application based on the determined lifetime value of the user.

14. The computer program product of claim 9, wherein the advertising schedule does not provide any advertisements to the user based upon a determination that the lifetime spending value of the user is above the expected value to the application developer for allowing the advertisements to be provided to the user.

15. A system to determine to serve mobile advertisements, comprising:
a storage device; and
a processor communicatively coupled to the storage device, wherein the processor executes application code instructions that are stored in the storage device to cause the system to:
receive user usage data for a particular application operating on a user computing device associated with a user, the particular application being provided by an application developer computing system;
analyze the user usage data to develop a profile of the interaction of the user with the application;
estimate a lifetime spending value of the user based on the identified user spending;
receive one or more rules from the application developer computing system for determining an advertising schedule for advertisements to be provided to the user on an application module of the particular application based on the estimated lifetime value of the user
receive a notification that the user is interacting with the particular application on the user computing device; and
provide a particular advertisement to the user to the user on the application module of the particular application based on the determined advertising schedule.

16. The system of claim 15, further comprising application code instructions provide an expected value to the application developer computing system to allow the advertisements to be provided to the user on an application module of the application.

17. The system of claim 15, wherein a particular rule of the one or more rules specifies that the user is to be placed on the advertising schedule if the lifetime spending value of the user is below a configure threshold.

18. The system of claim 15, wherein the advertising schedule provides a greater number of advertisements to the user based upon a determination that the lifetime spending value of the user is below a configure threshold and a lesser number of advertisements to the user based upon a determination that the lifetime spending value of the user is above a configure threshold.

19. The system of claim 15, wherein the advertising schedule does not provide any advertisements to the user based upon a determination that the lifetime spending value of the user is above a configure threshold.

20. The system of claim 16, wherein the advertising schedule does not provide any advertisements to the user based upon a determination that the lifetime spending value of the user is above the expected value to the application developer for allowing the advertisements to be provided to the user.
